(19) United States
(12) Patent Application Publication
(10) Pub. No.: US 2008/0223124 A1
(43) Pub. Date: Sep. 18, 2008

(54) Method for the Indirect Tire Pressure Monitoring

(75) Inventors: Markus Irth, Mainz-Kastel (DE); Andreas Kobe, Bensheim (DE); Christian Sussmann, Oberursel (DE); Franko Blank, Hodenhang (DE); Vladimir Koukes, Darmstadt (DE)

Correspondence Address: CONTINENTAL TEVES, INC., ONE CONTINENTAL DRIVE, AUBURN HILLLS, MI, 48326-1581, US

(73) Assignees: Continental Teves AG & Co. oHG; Continental Aktiengesellschaft

(21) Appl. No.: 12/093,626

(22) PCT Filed: Nov. 14, 2006
(86) PCT No.: PCT/EP2006/068442

§ 371 Date: May 14, 2008

(30) Foreign Application Priority Data
Nov. 14, 2005 (DE) 10 2005 054 556.4
Nov. 14, 2006 (DE) 10 2006 053 825.0

(51) Int. Cl. G01M 17/02; G01K 13/00

(52) U.S. Cl. 73/146; 374/143; 374/E13.001

(57) ABSTRACT

Method for the indirect tire pressure monitoring in which an analysis of the natural oscillation behavior of at least one tire is performed and at least one pressure loss analysis variable (f_{FL}, f_{FR}, f_{RL}, f_{RR}), in particular a natural frequency, is determined, in which case a temperature compensation (4) of the pressure loss analysis variable (f_{FL}, f_{FR}, f_{RL}, f_{RR}) is performed, and in which case a tire temperature (Tₜᵢᵣₑ) calculated by means of a temperature model (1) is used to determine a compensation quantity (2), in particular the quotient of variation of the pressure loss analysis variable and change in temperature.

### BACKGROUND OF THE INVENTION

The present invention relates to a method for the indirect tire pressure monitoring in which an analysis of the natural oscillation behavior of at least one tire is performed and at least one pressure loss analysis variable (f_{FL}, f_{FR}, f_{RL}, f_{RR}), in particular a natural frequency, is determined, in which case a temperature compensation (4) of the pressure loss analysis variable (f_{FL}, f_{FR}, f_{RL}, f_{RR}) is performed, and to a computer program product.

In up-to-date motor vehicles, systems are employed at an increasing rate, which contribute to an active or passive protection of the occupants. Systems for tire pressure monitoring protect the occupants of a vehicle against vehicle damages, which are due to an incorrect tire inflation pressure, for example. An abnormal tire inflation pressure can also cause increase of e.g. tire wear and fuel consumption, or a tire defect (tire bursting) may occur. Various tire pressure monitoring systems are known, which operate either based on directly measuring sensors or detect an abnormal tire pressure by evaluating rotational speed properties or oscillating properties of the vehicle wheels.

German patent application DE 100 58 140 A1 discloses a so-called indirectly measuring tire pressure monitoring system (DDS: Deflation Detection System) detecting tire pressure loss by evaluating the rotational movement of the wheel.

EP 0 578 826 B1 discloses a device for determining tire pressure which determines pressure loss in a tire based on tire oscillations.

EP 0 895 880 A2 discloses a device for estimating the inflation pressure of a tire which comprises a temperature sensor measuring the temperature of the outside air. Effects of the temperature on the resonance frequency of the tire are corrected based on the defined outside air temperature.

An object of the invention is to provide a tire pressure monitoring system for a motor vehicle based on the evaluation of the tire oscillations, in which the influence of the temperature is taken into consideration.

### SUMMARY OF THE INVENTION

According to the invention, this object is achieved by the method for the indirect tire pressure monitoring in which an analysis of the natural oscillation behavior of at least one tire is performed and at least one pressure loss analysis variable (f_{FL}, f_{FR}, f_{RL}, f_{RR}), in particular a natural frequency, is determined, in which case a temperature compensation (4) of the pressure loss analysis variable (f_{FL}, f_{FR}, f_{RL}, f_{RR}) is performed. A tire temperature (Tₜᵢᵣₑ) calculated by means of a temperature model (1) is used to determine a compensation quantity (2), in particular the quotient of variation of the pressure loss analysis variable and change in temperature.

The invention is based on the idea of determining a compensation quantity for at least one pressure loss analysis variable which is obtained by analysis of the torsion natural oscillation behavior of at least one tire. This compensation quantity depends on a tire temperature calculated by means of a temperature model.

It is preferred to use a quotient of a variation of the pressure loss analysis variable to a change in temperature for the compensation quantity. The quotient reflects directly the influence of the temperature on the pressure loss analysis variable.

It is likewise preferred that one compensation quantity is determined for each pressure loss analysis variable. This renders an individual correction of each pressure loss analysis variable possible.

The pressure loss analysis variable preferably concerns a natural frequency or natural frequency shift determined in a natural frequency analysis.

It is, however, also preferred that the pressure loss analysis quantity is a quantity which is obtained from the frequency shift and additional quantities that describe spectra, or a spring constant describing the tire.

According to a preferred embodiment, the temperature model employed considers at least one of the following changes in the quantity of heat in order to calculate the tire temperature: heat flow due to the flexing energy of the tire (\dot{Q}_{Walk}), heat flow due to convection (\dot{Q}_{Convection}), heat flow due to radiation of the tire (\dot{Q}_{Radiation}), heat flow due to heat input of the vehicle (\dot{Q}_{VehicleCondition}).

In an improvement of the invention, the compensation quantity/quantities is/are learnt, in which case the pressure loss analysis variable(s) is(are) considered together with the calculated tire temperature(s) over one or more travels in order to learn the compensation quantity/quantities. The learning operation over a long period allows safeguarding sufficient statistical relevance of the result.

Preferably, the tire temperature is determined by integration with time from the at least one change in the quantity of heat. With particular preference, the tire temperature is determined by integration of all changes in the quantity of heat.

In order to calculate the tire temperature, at least two of the following quantities are taken into consideration: outside temperature (T_{outside}), temperature in a control unit, engine air intake temperature, coolant temperature, engine temperature (T_{engine}), brake temperature (T_{brake}), immobilization time of the vehicle, driving profile since the ignition has been switched on, especially vehicle speed (v), yaw rate, lateral acceleration, drive torque and/or kilometers traveled, ambient sensor information, in particular rain sensor information and/or dew point sensor information.

One advantage of the method of the invention can be seen in the reduced danger of false alarms or the danger of the absence of alarms when pressure loss occurs.

The invention also relates to a computer program product which defines an algorithm according to the method described hereinabove.

Further preferred embodiments can be seen in the following description by way of the Figures.

### BRIEF DESCRIPTION OF THE DRAWINGS

In the accompanying drawings,

FIG. 1 is a schematic block diagram relating to temperature compensation in a frequency analysis; and

FIG. 2 is a schematic block diagram relating to a tire temperature calculation.

### DETAILED DESCRIPTION OF THE DRAWINGS

The tire temperature has an influence on the pressure in the tire. Following a raised tire temperature is an increase in tire pressure, hence, an increased rigidity of the tire and an increase in natural frequency. However, the rigidity of the tire material (rubber) is also influenced by the temperature. Ensuing from an increase in temperature is softer rubber, hence, a reduced rigidity and a reduction in natural frequency. It has proved that the two effects do not counterbalance each other in their influence on the tire and, thus, preferably on the natural frequency, but that the effect depends on material, tire temperature and internal pressure. During travels with high temperature variations, this causes changes of the torsion oscillation behavior of a tire which lie in the size range of the changes during pressure loss, what is accompanied by an increased danger of false alarms or the risk of no alarms during pressure loss.

The method of the invention is used in a system for the indirect monitoring of tire pressure in which an analysis of the natural oscillation behavior or one or more tires is performed. As this occurs, a pressure loss analysis variable is determined for at least one tire, preferably for each tire. The natural frequency shift f from the frequency analysis is used in the following description as an example for a pressure loss analysis variable. This is, however, also possible with a pressure loss analysis variable which results from the frequency shift and further quantities that describe spectra, as is e.g. described in detail in publication WO 2005/005174 A1, or likewise with a spring constant of the tire, as disclosed in EP 0 895 880 A2, for example. According to the example, a frequency shift is given for each wheel f_{FL}, f_{FR}, f_{RL}, f_{RR} (FR: front right, RR: rear right, FL: front left, RL: rear left).

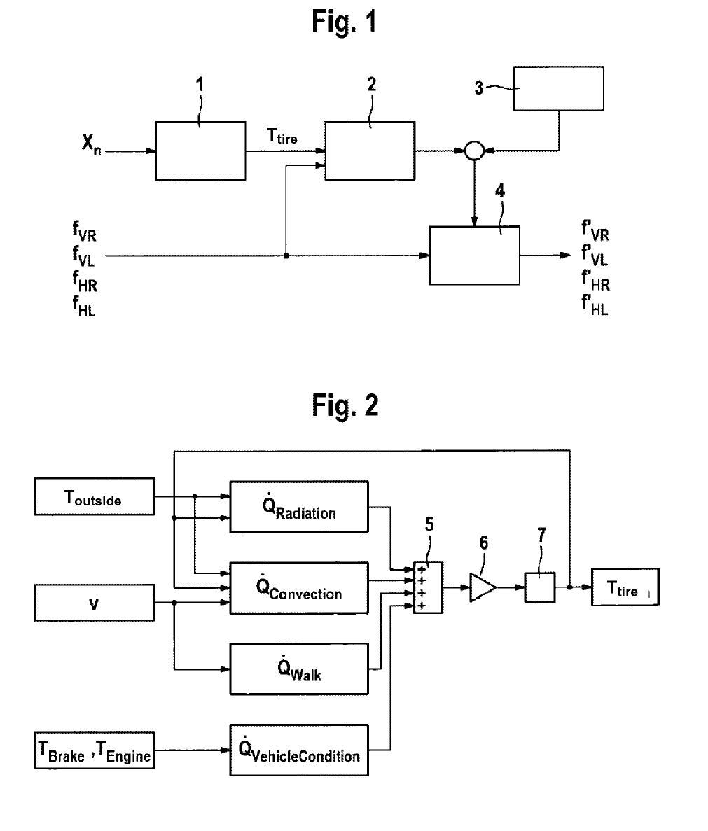

FIG. 1 illustrates a schematic block diagram of an exemplary method which solves the above-mentioned problem of the influence on the tire temperature. According to the example, the natural frequency fₖ (the index k can relate to FL, FR, RL, or RR) of the tire is taught in together with a calculated tire temperature Tₜᵢᵣₑ. A compensation quantity for the temperature influence is determined from this ensemble and is applied with regard to the determined natural frequencies fₖ. In the beginning, before a compensation value prevails, initially an empirical average value (e.g. −0.5 hertz/10° C.) is taken as a basic compensation 3. During the learning operation, a tire temperature Tₜᵢᵣₑ is then calculated by means of a temperature model 1, based on different items of information Xₙ related to driving, driving conditions, vehicle and environment, such as outside temperature, immobilization time, coolant temperature, driving speed, driving profile, etc. Furthermore, the natural frequencies of the wheels f_{FL}, f_{FR}, f_{RL}, f_{RR} are determined correspondingly. A correction factor 2 is taught in when temperature/frequency values prevail. The correction factor is used to determine from the basic compensation 3 an actual temperature compensation value 4 which allows determining the temperature-compensated natural frequencies f′_{FL}, f′_{FR}, f′_{RL}, f′_{RR}.

The spread of the temperature Tₜᵢᵣₑ is evaluated when the correction factor 2 is learnt. The correction factor 2 will not be accepted until the spread of the learnt temperature/frequency ensemble with regard to the temperature Tₜᵢᵣₑ (e.g. lowest temperature to highest temperature and a sufficient number of pairs of values above this range) is of sufficient size.

The temperature model 1 uses the following pieces of information, for example, for the calculation of the tire temperature Tₜᵢᵣₑ:
Outside temperature T_{outside}, obtainable either by way of a temperature sensor in the control unit or by way of CAN messages, such as the combined outside temperature and intake air temperature,
Immobilization time of the vehicle: Assessment sometimes by way of the coolant temperature or engine temperature T_{Engine} in combination with the outside temperature T_{outside}, in case there is no immobilization time,
driving profile, obtainable from the speed signal v, yaw rate or lateral acceleration as well as drive torque. In addition, calculated quantities such as kilometers traveled since ‘ignition-on’, and
rain sensor or dew point sensor information in order to infer the moisture of the road therefrom.

These pieces of information are combined by means of a temperature model 1 which enters the heat flow \dot{Q} through flexing energy \dot{Q}_{Walk}, convection \dot{Q}_{Convection} and radiant heat \dot{Q}_{Radiation} into the balance sheet in a first embodiment and calculates a tire temperature therefrom. In another term \dot{Q}_{VehicleCondition} for ambient conditions, influences of the vehicle such as brake temperature and engine temperature are taken into consideration.

Possible equations for calculation are:

### Radiation/Radiant Heat:

\dot{Q}_{Radiation}=ε·σ·A·(T_{outside}⁴−Tₜᵢᵣₑ⁴)=αₛ(T_{outside}⁴−Tₜᵢᵣₑ⁴)

### Convection:

\dot{Q}_{Convection}=αₖ·\sqrt{v}·(T_{outside}−Tₜᵢᵣₑ)

### Flexing Energy:

\dot{Q}_{Walk}=f·m·g·v=f·F_{z}·v

### Vehicle Conditions/Vehicle Heat Input:

\dot{Q}_{VehicleCondition}=f(T_{Brake},T_{Engine}, . . . )

with
ε: emissivity,
σ: Stefan-Boltzmann constant,
A: radiating surface of the tire,
α_{S}: proportionality constant of the radiant heat,
αₖ: proportionality constant of the convection,
f: proportionality constant of the rolling resistance,
F_{z}: wheel load,
v: speed,
T_{outside}: outside temperature,
Tₜᵢᵣₑ: tire temperature, and
f (T_{Brake}, T_{Engine}, . . . ): function of the brake temperature T_{Brake}, the engine temperature T_{Engine} and further quantities.

The tire temperature Tₜᵢᵣₑ can be calculated by integration of the changes of the quantity of heat according to:

$${T}_{tire} = 1 / {c}_{tire} \cdot \int ( {\dot{Q}}_{Convection} + {\dot{Q}}_{Radiation} + {\dot{Q}}_{Walk} + {\dot{Q}}_{VehicleCondition} ) d t + {T}_{Start}$$

with cₜᵢᵣₑ: heat capacity of the tire, and Tₛₜₐᵣₜ: start value.

FIG. 2 schematically illustrates an exemplary method for the calculation of the tire temperature Tₜᵢᵣₑ according to the above equation. Based on outside temperature T_{outside}, driving speed v, brake temperature T_{Brake}, engine temperature T_{Engine} and a start value T_{Start} for the tire temperature, the four heat flow contributions \dot{Q}_{Walk}, \dot{Q}_{Convection}, \dot{Q}_{Radiation} and \dot{Q}_{VehicleCondition} are calculated, added in block 5, divided in block 6 by the heat capacity cₜᵢᵣₑ and integrated as a function of time in block 7. The resultant tire temperature Tₜᵢᵣₑ is used to calculate new heat flow contributions \dot{Q}_{Convection}, \dot{Q}_{Radiation}.

In an especially simple embodiment, the radiation component \dot{Q}_{Radiation} is ignored. A minimum speed v in the capacity of an input for the convection equation is assumed as a compensation for the hence missing temperature reduction.

Plausibilisation values from the immobilization time must be taken into account to determine a start value Tₛₜₐᵣₜ.

1-6. (canceled)

7. A method for indirect tire pressure monitoring comprising:
analyzing natural oscillation behavior of at least one tire is performed;
determining at least one pressure loss analysis variable (f_{FL}, f_{FR}, f_{RL}, f_{RR}); and
performing a temperature compensation (4) of the pressure loss analysis variable (f_{FL}, f_{FR}, f_{RL}, f_{RR}) is performed, wherein a tire temperature (Tₜᵢᵣₑ) calculated by means of a temperature model (1) is used to determine a compensation quantity (2), such as a quotient of variation of the pressure loss analysis variable and change in temperature.

8. The method of claim 7, wherein the temperature model (1) considers at least one of the following changes of the quantity of heat: heat flow due to the flexing energy of the tire (\dot{Q}_{Walk}), heat flow due to convection (\dot{Q}_{Convection}), heat flow due to radiation of the tire (\dot{Q}_{Radiation}), heat flow due to heat input of the vehicle (\dot{Q}_{VehicleCondition}).

9. The method of claim 7, wherein the pressure loss analysis variable (f_{FL}, f_{FR}, f_{RL}, f_{RR}) is considered together with the calculated tire temperature (Tₜᵢᵣₑ) over one or more travels in order to learn in the compensation quantity.

10. The method of claim 7, wherein the tire temperature (Tₜᵢᵣₑ) is determined by integration with time from the at least one change of the quantity of heat (\dot{Q}_{Walk}, \dot{Q}_{Convection}, \dot{Q}_{Radiation}, \dot{Q}_{VehicleCondition}), in particular from all changes of the quantity of heat.

11. The method of claim 7, wherein the tire temperature (Tₜᵢᵣₑ) is calculated by taking at least two of the following quantities into consideration: outside temperature (T_{outside}), temperature in a control unit, engine air intake temperature, coolant temperature, engine temperature (T_{engine}), brake temperature (T_{brake}), immobilization time of the vehicle, driving profile since the ignition has been switched on, especially vehicle speed (v), yaw rate, lateral acceleration, drive torque and/or kilometers traveled, ambient sensor information, in particular rain sensor information and/or dew point sensor information.

12. The method of claim 7, wherein the at least one pressure loss analysis variable (f_{FL}, f_{FR}, f_{RL}, f_{RR}) is a natural frequency
